(19) United States
(12) Patent Application Publication
(10) Pub. No.: US 2017/0350996 A1
(43) Pub. Date: Dec. 7, 2017

(54) Seismic Source Installation/Anchoring System and Method

(71) Applicant: GreenPowerUSA Inc., Chatsworth, CA (US)

(72) Inventor: James K. Andersen, Woodland Hills, CA (US)

(73) Assignee: GreenPowerUSA Inc, Chatsworth, CA (US)

(21) Appl. No.: 15/594,453

(22) Filed: May 12, 2017

Related U.S. Application Data
(60) Provisional application No. 62/345,281, filed on Jun. 3, 2016.

(51) Int. Cl. G01V 1/047

(52) U.S. Cl. CPC G01V 1/047

(57) ABSTRACT

A seismic source system uses at least one seismic source, a screw in piling ground anchor installed into the earth/ground and means of coupling the energy from the seismic source to the screw in piling ground anchor.

### CROSS REFERENCE TO RELATED APPLICATIONS

This application is a non-provisional application which claims priority from U.S. Ser. 62/345,281, filed Jun. 3, 2016.

### FIELD OF THE INVENTION

This invention relates to seismic sources used for determining the structure of the earth's subsurface. Specifically, it provides a simple means of effectively coupling seismic sources to the earth to facilitate maximum transmission of their seismic energy into the earth. It can also be used to couple seismic vibrations from the earth to seismic sensors.

### BACKGROUND OF THE INVENTION

Seismic sources are used to introduce controlled acoustic waves into the subsurface such that their direct and/or reflected waves can be detected by sensitive sensors at the surface or downhole. The detected energy is typically collected and processed and used to develop images of the subsurface. These subsurface images are regularly used by oilfield companies to locate, monitor, and enhance the recovery from subsurface oil & gas deposits. Subsurface images are also by other industries such as mining, excavation, water, environmental, and even by governments to detect subsurface tunnels.

In order for a seismic source to transmit energy into the earth, it must be connected or coupled to the earth. The efficiency of the transmission (i.e., how much of the vibration from the source is translated into vibration of the ground) depends upon the degree of coupling of the source to the earth. There are many methods of coupling the vibration to the earth. For surface sources, the most common method is to use a heavy weight to hold a flat plate against the ground while the plate is subjected to vibration. The heavy weight ensures intimate contact of the vibrating plate with the ground and thus good acoustic coupling. Although commonly used, this method requires heavy equipment/vehicles that are expensive and difficult to transport, and in addition, can be very lossy depending upon the firmness of the surface. Another means of ensuring good coupling is direct burial of the source, usually surrounding it by cement. This provides excellent coupling but digging the holes and cementing the source is time consuming, expensive, and makes the source inaccessible for repair or relocation. Another method is to place concrete pillars in the earth leaving the top surface exposed (usually with mounting bolts) so that the vibratory sources can be attached when needed. This method ensures the sources are accessible for repairs and can be relocated, however, the pillars are time consuming and expensive to install, their weight can reduce the magnitude of the vibrations going into the earth, and the depth of the pillar may not be sufficient to be in contact with good load bearing soil.

### SUMMARY OF THE INVENTION

The present invention provides a simple, low cost, easy to install, yet very effective means for coupling the vibrations from a seismic source into the earth. According to this invention, a screw in piling (sometimes also referred to as a screw pile, screw anchor, helical pile, helical anchor, etc.) is rotated into the earth using a backhoe mounted auger fitting or other appropriate means. A seismic source is rigidly attached to the top of the screw in piling via a compatible mounting system/plate, and when the source is energized, the energy/vibrations are transferred down the length of helical pile and into the earth.

Accordingly, it is an object of the present invention to provide a better system and method for anchoring seismic sources.

This and further objects and advantages will be apparent to those skilled in the art in connection with the drawings and the detailed description of the invention set forth below.

### BRIEF DESCRIPTION OF THE DRAWINGS

FIGS. 1 and 2 illustrate examples of screw in pilings.

### DETAILED DESCRIPTION OF THE INVENTION

The present invention is generally directed to a seismic source system and installation and anchoring method which uses at least one seismic source, a screw in piling type ground anchor installed into the earth/ground, and means of coupling the energy from the seismic source to the screw in piling ground anchor.

A typical screw in piling can be anywhere from a few feet long to upwards of 50 feet long. (These pilings are regularly used to install street light poles, foundations, etc., as a more economical means than using cement.) In a preferred embodiment, the top of the screw in piling has a mounting plate that is compatible with mounting a vibratory seismic source. A screw in piling provides excellent mechanical coupling to the earth in both compression and tension which is a must for this application. Cement/concrete pilings are excellent in compression but are typically weak in tension requiring substantial reinforcement. Pounded in pilings rely primarily on friction and are therefore their performance in tension and compression is not uniform or predictable.

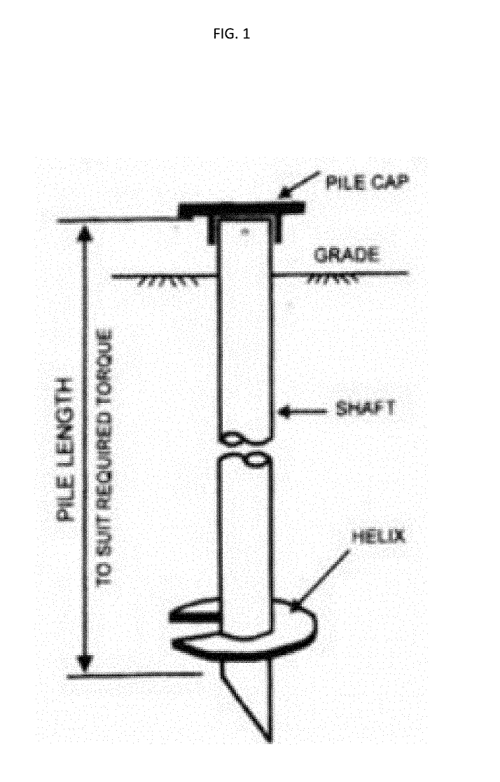

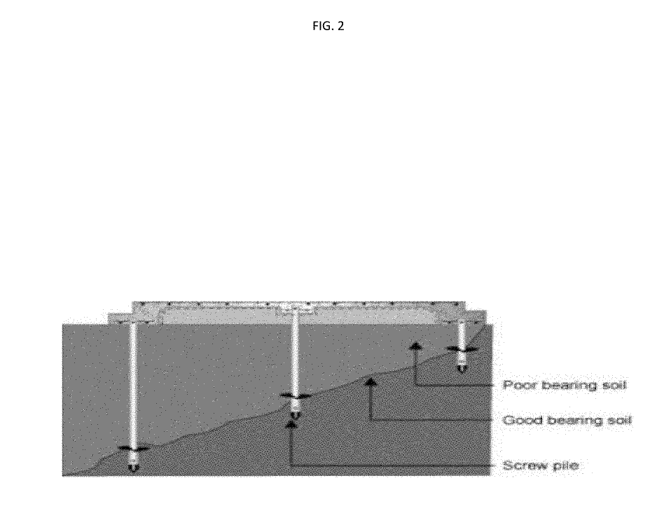

FIGS. 1 and 2 show examples of screw in pilings; note that the length of the screw in piling can be varied depending upon the depth to good load bearing soil. The length of the screw in piling should be adjusted to ensure the helix is fastened into good load bearing soil. One or more helixes can be attached to the screw in piling shaft, as desired for the particular application.

Once installed, the load (seismic source) can be attached and used immediately. Multiple screw in pilings can be temporarily or permanently installed at desired locations optimized for obtaining the best subsurface information.

In other aspects of the present invention, the seismic source can be vibratory, impulsive, a rotary vibrator, a linear vibrator, or a rotary vibrator that produces linear vibratory motion. The coupling means can be via one or more mechanical fasteners, via welding, or via adhesive bonding. The seismic source can be electrically powered, pneumatically powered, or hydraulically powered. The screw in piling ground anchor can be permanently installed, or multiple screw in piling ground anchors can be permanently installed at fixed locations to facilitate repeated seismic surveys, or the seismic source can be designed to be moved and coupled to various previously installed screw in piling ground anchors to perform a seismic survey. In the context of the present invention, permanently installed does not mean that the screw in piling could never be reversed and removed, just that there is a standard process for doing so, and that the predetermined amount of torque required to reverse it, is much above any naturally occurring forces or the vibratory forces of the seismic source. In other words, it is permanent until one desires to remove it. The predetermined installation torque is calculated to provide a sufficient bearing load (with adequate safety factor) as needed for the force generated by any seismic source used with it. The seismic source can be designed to be permanently affixed to an individual screw in piling anchor system, where one or more screw in pilings can be installed for large area and/or repeated seismic surveys, and the seismic source can be controlled/actuated from a remote location. The screw in piling can be screwed in to the earth/ground to a predetermined torque that is calculated to provide sufficient bearing load as needed for the force generated by the particular seismic source being used.

It is worth noting that a seismic source system in accordance with the present invention is much simpler and less expensive to install that conventional seismic source systems, so such a system can include more screw in pilings fitted with sensors or seismic sources. In addition, because of the way a screw in piling is installed, it will be at ground surface, which makes any sensor or seismic source mounted to it much more accessible for removal and/or servicing, which represents a significant improvement over the current state of the art. Accordingly, the present invention provides a seismic receiver system in which the screw in piling ground anchor serves as a simple and easy way to install, protect, and couple downhole seismic sensors to the earth, essentially providing the equivalent of a well bore used for observation, cross well surveys, etc.

While the invention has been described herein with reference to certain preferred embodiments, those embodiments have been presented by way of example only, and not to limit the scope of the invention. Additional embodiments thereof will be obvious to those skilled in the art having the benefit of this detailed description.

Accordingly, it will be apparent to those skilled in the art that still further changes and modifications in the actual concepts described herein can readily be made without departing from the spirit and scope of the disclosed inventions.

What is claimed is:

1: A seismic source system, comprising:
a seismic source;
a screw in piling ground anchor installed into the earth; and
a means of coupling energy from the seismic source to the screw in piling ground anchor.

2: The seismic source system of claim 1, wherein the screw in piling ground anchor is permanently installed into the earth at a first fixed location.

3: The seismic source system of claim 2, comprising a second screw in piling ground anchor permanently installed at a second fixed location.

4: The seismic source system of claim 3, wherein the seismic source can be moved between, and coupled to, each of the first and second fixed locations.

5: The seismic source system of claim 1, wherein the seismic source is permanently affixed to the screw in piling.

6: The seismic source system of claim 1, wherein the seismic source can be controlled from a remote location.

7: The seismic source system of claim 1, wherein the screw in piling is screwed into the earth to a predetermined torque that is calculated to provide a sufficient bearing load as needed for the force generated by the seismic source.

8: The seismic source system of claim 1, further comprising a plurality of sensors that detect vibration from the seismic source or other seismic sources or events.

9: The seismic source of claim 1, wherein a seismic sensor is attached to the screw in piling.

10: The seismic source of claim 1, wherein the seismic source is vibratory.

11: The seismic source of claim 1, wherein the seismic source is impulsive.

12: The seismic source of claim 1, wherein the seismic source is selected from the group consisting of a rotary vibrator, a linear vibrator and a rotary vibrator that produces linear vibratory motion.

13: The seismic source of claim 1, wherein the coupling means is via one or more mechanical fasteners.

14: The seismic source of claim 1, wherein the coupling means is selected from the group consisting of welding or adhesive bonding.

15: A process for creating a seismic source system, comprising the steps of:
(1) screwing a screw in piling into a ground surface to a predetermined torque calculated to provide a sufficient bearing load for force generated by a seismic source to be used with the screw in piling; and
(2) coupling the seismic source to the screw in piling.

16: The process of clam 15, wherein steps 1 and 2 are repeated at least once.
